(19) United States
(12) Patent Application Publication
(10) Pub. No.: US 2010/0011228 A1
(43) Pub. Date: Jan. 14, 2010

(54) Power supply

(76) Inventors: Chien-Hung Chen, Chung-Ho City (TW); Wei-Jen Kuo, Chung-Ho City (TW); Tung Yao Yu, Taipei (TW); Ching-Hsiung Yang, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/216,654

(22) Filed: Jul. 9, 2008

(51) Int. Cl. G06F 1/26

(52) U.S. Cl. 713/300

(57) ABSTRACT

A power supply allows an electronic product to access the Internet, characterized in that a casing of the power supply is provided with a network connection port, the casing of the power supply is provided therein with a power line communication module, the power line communication module is coupled to the network connection port, the power line communication module receives an original package data and transmits the original package data to the electronic product via the network connection port.

### BACKGROUND OF THE INVENTION

1. Field of the Invention

The present invention relates to a power supply, and in particular to a power supply capable of providing power and Internet service to an electronic product.

2. Description of Related Art

Please refer to FIG. 1, which is a schematic view showing the external appearance of a conventional power supply. The power supply 10 adopts AC/DC conversion to provide multiple sets of output power for a personal computer 20. When the power input port 12 of the power supply 10 is connected to an AC public power (i.e. utility power), the power supply 10 will convert the AC public power into a 5VSB (Standby Voltage) for output voltage and then deliver the output voltage to the personal computer 20 via a power output cable 14. After starting, the personal computer 20 outputs a power-on signal to the power supply 10 to order the power supply 10 to provide respective output voltages of 3.3V, 5.0V, 12V, −12V together with a “power good signal”.

Please refer to FIGS. 1 and 2. FIG. 2 is a schematic block diagram showing the circuit of the conventional power supply. The power supply 10 includes an electromagnetic interference (EMI) filter 102 and an alternating current/direct current (AC/DC) converter 104. The EMI filter 102 receives the AC public power and transmits the received AC public power to the AC/DC converter 104. Then, the AC/DC converter 104 converts the AC public power into respective output voltages of 3.3V, 5.0V, 12V and −12V for the personal computer 20.

Furthermore, on the basis of the standard of Home Plug version 1.0, different standards have been developed, such as Consumer Electronics Powerline Communication Alliance (CEPCA), Home Plug Power Line Alliance, Institute of Electrical and Electronics Engineers (IEEE), European Telecommunications Standards Institute Powerline Technology (ETSIPLT), Lonworks, Oil, Petrochemical and Energy Risks Association (OPERA), Powemet, and Universal Powerline Association. Also, Power Line Communication (PLC) technology is well-developed, and the PLC is a communication technology that utilizes power lines to transmit data and voicemail. With the development of network technology, much attention has been paid to the importance of high-speed data transmission via low-voltage power lines because the high-speed data transmission has many advantages as follows, such as no need to arrange lines again, large range of coverage, easy connection and high transmission speed.

Please refer to FIG. 3, which is a schematic block diagram showing a framework of a conventional power line communication. The power line communication utilizes a household power line 30 as a broadband communication transmission medium. The user only needs to connect a PLC modem 32 to the public power outlet to access the broadband communication directly via the power line. As a result, the problem that the telecommunication service provider has to arrange lines to individual user's house to achieve the broadband communication service can be avoided. Although the PLC modem 32 allows a computer 34 to access the Internet via power lines, in comparison with the household Internet service achieved by single ADSL modem, each computer 34 has to be equipped with an additional power line. That is to say, each computer has to use an additional power outlet. As a result, the number of the total lines of the computer 34 is increased, which makes the collection of lines troublesome.

### SUMMARY OF THE INVENTION

In view of the above, the present invention is to provide a power supply capable of providing power and a communication service to an electronic product, so that the electronic product can get power for work and access the Internet simultaneously without an additional power line that occupies an extra power outlet.

The power supply of the present invention provides the necessary communication service to an electronic product, characterized in that: a casing of the power supply is provided with a network connection port, the interior of the casing of the power supply is provided with a power line communication module, the power line communication module is coupled to the network connection port, the power line communication module receives an original package data and transmits the original package data to the electronic product via the network connection port. Furthermore, the interior of the casing of the power supply is provided with an EMI filter and a power converter. The EMI filter is coupled to a power line and the power line communication module. The EMI filter receives an AC power and the original package data, and transmits the original package data to the power line communication module. The power converter is coupled to the EMI filter, the electronic product, the network connection port and the power line communication module. The power converter converts the AC power into a DC power which is supplied to the electronic product, and also converts the AC power into an auxiliary power which is supplied to the network connection port and the power line communication module.

According to the above, the present invention provides a power supply that is capable of providing power and a communication service to an electronic product simultaneously, so that it is unnecessary to arrange an additional line to allow a computer to get power for work and access the Internet. Therefore, the problem that the increased number of lines makes the collection of lines troublesome in prior art can be solved.

### BRIEF DESCRIPTION OF THE DRAWINGS

FIG. 1 is a schematic view showing the external appearance of a conventional power supply;

FIG. 2 is a schematic block diagram showing the circuit of a conventional power supply;

FIG. 3 is a schematic block diagram showing the framework of a conventional power line communication;

FIG. 4 is a schematic view showing the external appearance of the power supply in accordance with a first embodiment of the present invention;

FIG. 5 is a schematic block diagram showing the circuit of the power supply of the present invention;

FIG. 6 is a schematic block diagram showing the power line communication module of the present invention; and

FIG. 7 is a schematic view showing the external appearance of the power supply in accordance with a second embodiment of the present invention.

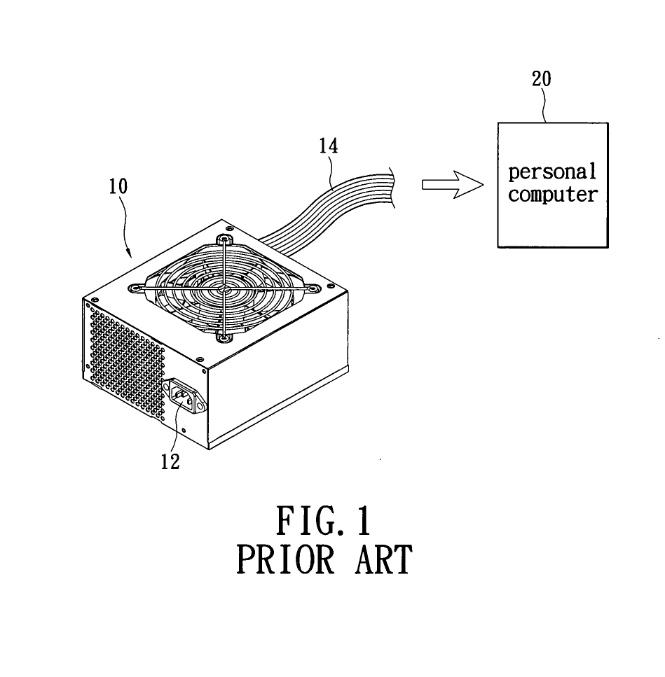

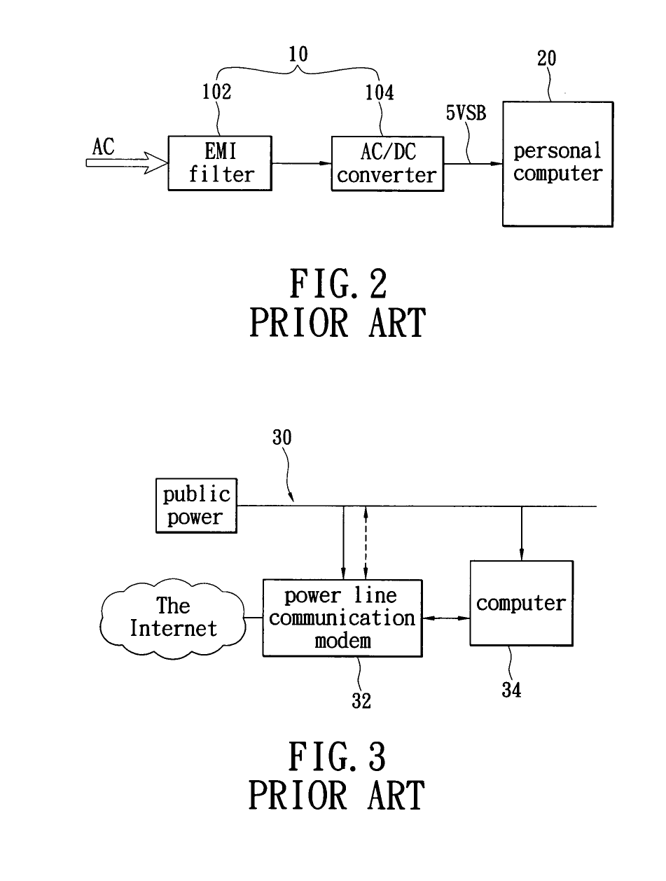

### DETAILED DESCRIPTION OF THE PREFERRED EMBODIMENTS

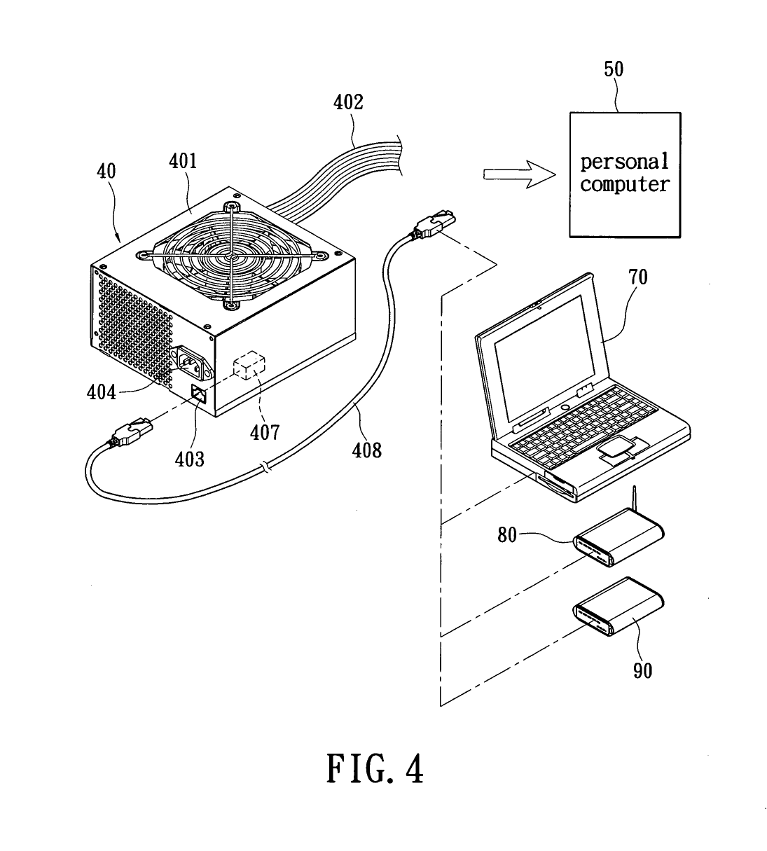

Please refer to FIG. 4, which is a schematic view showing the external appearance of the power supply in accordance with the first embodiment of the present invention. In the first embodiment, the power supply 40 of the present invention utilizes AC/DC conversion to provide multiple sets of output voltages to an electronic product. The electronic product is a personal computer 50. When a public power input port 404 of the power supply 40 is connected to the AC public power (i.e. public utility power), the power supply 40 converts the AC public power into respective output voltages of 33V, 5.0V, 12V and −12V and delivers these respective output voltages to the personal computer 50 via a power output cable 402. After starting, the personal computer 50 outputs a power-on signal to the power supply 40 so as to order the power supply 40 to provide the respective output voltages of 3.3V, 5.0V, 12V and −12V together with a “power good signal”.

A casing 401 of the power supply 40 is provided thereon with a network connection port 403. The interior of the casing 401 of the power supply 40 is provided with a power line communication module 407. The power line communication module 407 is coupled to the network connection port 403. The network connection port 403 can achieve a network communication connection with the personal computer 50, a notebook computer 70, a wireless hub 80, a cable hub 90, or other communication devices (not shown) by means of a network line 408. In this way, the power line communication module 407 obtains the network package data from the AC public power, and transmits the obtained network package data to the personal computer 50, the notebook computer 70, the wireless hub 80, the cable hub 90, or other communication devices (not shown) via the network connection port 403 according to the IP address of the network package data, so that the object of accessing the Internet can be achieved. The above-mentioned network connection port 403 may be a RJ45 connecting port or a RJ11 connecting port, but it is not limited thereto. Therefore, the power supply 40 of the present invention can provide power and the Internet service to the personal computer 50 simultaneously, so that it is unnecessary to achieve a network connection via an additional cable modem or PLC modem. Thus, the arrangement of lines can be reduced. Furthermore, the power supply 40 of the present invention can provide an Internet service to the notebook computer 70, the wireless hub 80, the cable hub 90 or other communication devices (not shown).

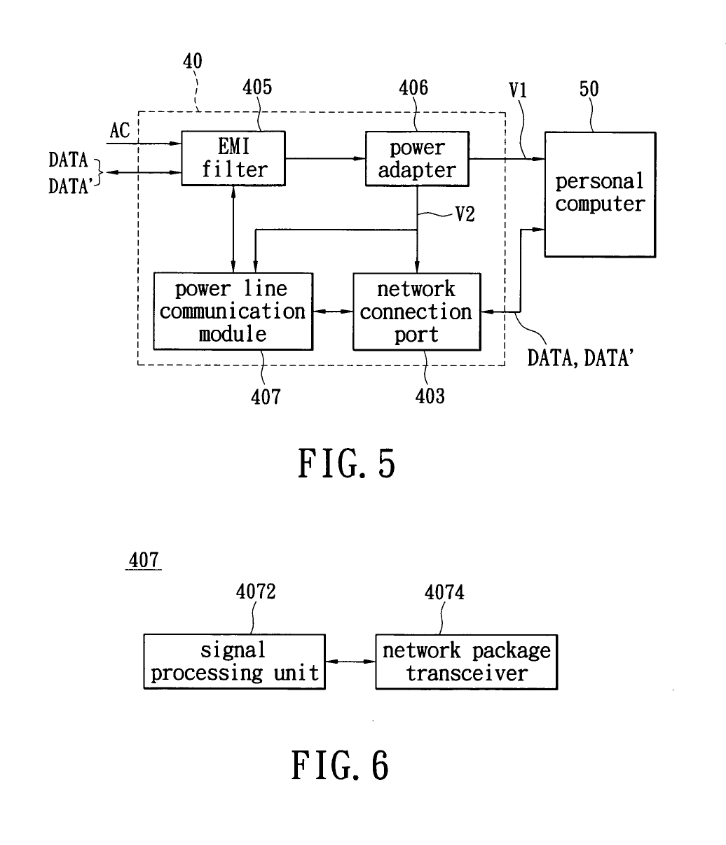

Please refer to FIG. 5 in conjunction with FIG. 4, wherein FIG. 5 is a schematic block diagram showing the circuit of the power supply of the present invention. The power supply 40 of the present invention can provide power for work and an Internet service to the personal computer 50. The casing 401 of the power supply 40 is provided with a network connection port 403. The interior of the casing 401 of the power supply 40 is provided with an electromagnetic interference (EMI) filter 405, a power converter 406 and a power line communication module 407. The EMI filter 405 is coupled to a power line and receives an AC power and an original package data DATA from the power line. The power converter 406 is coupled to the EMI filter 405 and the personal computer 50. The power converter 406 receives the AC power, converts the AC power into a DC power V1 and an auxiliary power V2, and then outputs the DC power V1 to the personal computer 50. The network connection port 403 is coupled to the power converter 406 and the personal computer 50. The network connection port 403 receives the auxiliary power V2. The power line communication module 407 is coupled to the EMI filter 405, the power converter 406 and the network connection port 403. The power line communication module receives the auxiliary power V2 and the original package data and transmits the received original package data to the personal computer 50 via the network connection port 403.

Please refer to FIG. 6 in conjunction with FIG. 5, wherein FIG. 6 is a schematic block diagram showing the power line communication module of the present invention. The power line communication module 407 includes a signal processing unit 4072 and a network package transceiver 4074. The signal processing unit 4072 is coupled to the EMI filter 405. The signal processing unit 4072 obtains the original package data from the EMI filter 405 or loads a returned package data to the power line via the EMI filter 405. The network package transceiver 4074 is coupled to the signal processing unit 4072 and the network connection port 403. The network package transceiver 4074 transmits the original package data DATA to the personal computer 50 via the network connection port 403, and then receives a returned package data DATA′ from the personal computer 50 via the network connection port 403.

Please refer to FIGS. 5 and 6. The network package transceiver 4074 used in the present invention is connected to the EMI filter 405 via the signal processing unit 4072, which obtains the original package data DATA from the AC public power in the power line, and then transmits the original package data DATA to the personal computer 50 via the network connection port 403 according to the target IP address of the original package data DATA. Furthermore, the network package transceiver 4074 is able to obtain the returned package data DATA′ from the personal computer 50. The returned package data DATA′ is loaded in the AC public power of the power line via the single processing unit 4072 and the EMI filter 405, so that the returned package data can be transmitted to a remote network center (not shown) by means of the power line. In this way, the power supply 40 of the present invention can provide Internet service to the personal computer 50 without an additional network connection to the computer via a cable modem or PLC modem, thereby reducing the arrangement of lines.

Please refer to FIGS. 5 and 6. The power converter 406 of the present invention obtains the AC public power from the power line via the EMI filter 405, and converts the AC public power into a DC power V1 and an auxiliary power V2. The DC power V1 is supplied to the personal computer 50 as a power source for the circuit, while the auxiliary power V2 is supplied to the power line communication module 407 and the network connection port 403 as a power source for those circuits. The power converter 406 may be a forward power converter, a half-bridge power converter, a full-bridge power converter, a push-pull power converter, or a fly-back power converter.

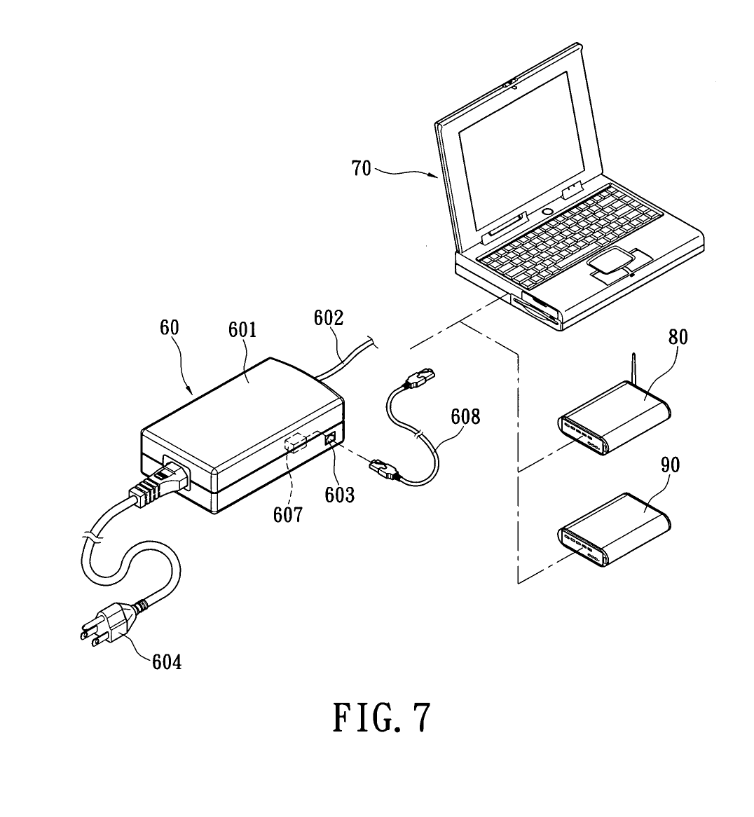

Furthermore, please refer to FIG. 7, which is a schematic view showing the external appearance of the power supply in accordance with the second embodiment of the present invention. In the second embodiment, the creative concept of the power supply 60 of the present invention is the same as that of the power supply 40 in the first embodiment. The primary difference between the second embodiment and the first embodiment lies in that the power supply 60 of the second embodiment is a power adapter for a portable computer, which utilizes AC/DC conversion to provide single set of output power to an electronic product. The above-mentioned electronic product is a notebook computer 70, a wireless hub 80, a cable hub 90, or other communication devices (not shown). When the public power input port 604 of the power supply 60 is connected to the AC public power (i.e. utility power), the power supply 60 converts the AC public power into a DC output voltage. After the notebook computer 70, the wireless hub 80 or the cable hub 90 has started, the DC output voltage is delivered to the notebook computer 70, the wireless hub 80, or the cable hub 90 via the power output cable 602, thereby providing the necessary power for the internal circuits.

The casing 601 of the power supply 60 is provided with a network connection port 603, and the interior of the casing 601 of the power supply 60 is provided with a power line communication module 607. The power line communication module 607 is coupled to the network connection port 603. The network connection port 603 can achieve a network communication connection with the notebook computer 70, the wireless hub 80, or the cable hub 90 via a network line 608. In this way, the power line communication module 607 obtains the network package data from the AC public power, and provides the network package data to the notebook computer 70, the wireless hub 80, or the cable hub 90 via the network connection port 603 according to the IP address of the network package data, so that the computer can access the Internet. The above-mentioned network connection port 603 can be a RJ45 connecting port or a RJ11 connecting port, but it is not limited thereto. Therefore, the power supply 60 of the present invention can simultaneously provide power and Internet service to the notebook computer 70, the wireless hub 80 or the cable hub 90 without an additional power line or power outlet.

According to the above, the power supply of the present invention can obtain an AC public power via a power line, and convert the AC public power respectively into a DC power for a personal computer, notebook computer, wireless hub, or cable hub; and also convert the AC public power into an auxiliary power for other circuits. Furthermore, according to the power supply of various embodiments of the present invention, the power line communication module is coupled between the power line and the personal computer as a transmission medium for the network package data, thereby allowing the personal computer to access the Internet via the power line. Alternatively, the power line communication module is coupled between the power line and the notebook computer as a transmission medium for the network package data, thereby allowing the notebook to access the Internet via the power line. Alternatively, the power line communication module is coupled between the power line and the wireless hub as a transmission medium for the network package data, thereby allowing the wireless hub to access the Internet via the power line. Alternatively, the power line communication module is coupled between the power line and the cables hub as a transmission medium for the network package data, thereby allowing the cable hub to access the Internet via the power line.

Therefore, the power supply of the present invention only needs one power line to provide power for work and a network communication to a personal computer, notebook, wireless hub or cable hub without an additional line. Thus, the problem of prior art that has increased number of lines may make the collection of lines troublesome can be solved.

While the present invention has been described in terms of what is presently considered to be the most practical and preferred embodiments, it is to be understood that the present invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A power supply for providing an electronic product with Internet service, characterized in that: a casing of the power supply is provided with a network connection port, the interior of the casing of the power supply is provided with a power line communication module, the power line communication module is coupled to the network connection port, and the power line communication module is coupled to a power line and receives an original package data from the power line and transmits the original package data to the electronic product via the network connection port.

2. The power supply according to claim 1, wherein the network connection port achieves a network communication connection with the electronic product via a network line.

3. The power supply according to claim 2, wherein the casing of the power supply is further provided therein with an electromagnetic interference (EMI) filter, the EMI filter is coupled between the power line and the power line communication module, the EMI filter receives an AC power and the original package data from the power line and transmits the original package data to the power line communication module.

4. The power supply according to claim 3, wherein the casing of the power supply is further provided therein with a power converter, the power converter is coupled to the EMI filter, the electronic product, the network connection port and the power line communication module, the power converter converts the AC power into a DC power and an auxiliary power, and then outputs the DC power to the electronic product and outputs the auxiliary power to the network connecting module and the power line communication module.

5. The power supply according to claim 4, wherein the power line communication module comprises:
a signal processing unit coupled to the EMI filter, the signal processing unit obtains the original package data from the EMI filter, or loads a returned package data to the power line via the EMI filter; and
a network package transceiver coupled to the signal processing unit and the network connection port, the network package transceiver transmits the original package device to the electronic product via the network connection port and the network line, and receives the retuned package data from the electronic product via the network connection port and the network line.

6. The power supply according to claim 5, wherein the electronic product is a notebook computer, a personal computer, a cable hub, or a wireless hub.

7. The power supply according to claim 4, wherein the power supply is a forward power supply, a half-bridge power supply, a full-bridge power supply, a push-pull power supply, or a fly-back power supply.

8. The power supply according to claim 1, wherein the network connection port is a RJ45 connecting port or a RJ11 connecting port.

9. A power supply, a casing thereof being provided thereon with a network connection port, and the interior of the casing of the power supply being provided with a power line communication module.

10. The power supply according to claim 9, wherein the power supply is a power supply for a personal computer, or a power adapter for a portable computer.

11. The power supply according to claim 9, wherein the network connection port is coupled to the power line communication module, and the casing of the power supply is provided therein with an EMI filter coupled to the power line communication module, and a power adapter which is coupled to the EMI filter, the network connection port and the power line communication module.
